(19) United States
(12) Patent Application Publication
(10) Pub. No.: US 2015/0089481 A1
(43) Pub. Date: Mar. 26, 2015

(54) METHODS, SYSTEMS AND COMPUTER-READABLE MEDIA FOR QUANTIFYING A BUG DETECTION EFFICIENCY OF A BUG PREDICTION TECHNIQUE

(71) Applicant: Infosys Limited, Bangalore (IN)

(72) Inventors: Anjaneyulu Pasala, BANGALORE (IN); Padmalochan Bera, PIN (IN); Tom Nedumgad, WESSELING (DE)

(21) Appl. No.: 14/493,309

(22) Filed: Sep. 22, 2014

(30) Foreign Application Priority Data
Sep. 23, 2013 (IN) 4294/CHE/2013

(51) Int. Cl. G06F 11/36; G06F 9/44

(52) U.S. Cl. CPC G06F 11/36; G06F 8/71
USPC 717/124

(57) ABSTRACT

The present invention provides a method and system for quantifying a bug preventability measure of a bug prediction technique. In accordance with a disclosed embodiment, the method may include applying a weighted recursive function, on an actual bug count of each version of an application, for computing a golden bug count of the each version. Further, the method shall include deriving a set of source code parameters of the application and applying a linear regression model, on the set of source code parameters of the each version of the application in order to calculate a predicted bug count for the each version. A bug deviation ratio, which shall be indicative the bug preventability measure, can be defined as a ratio of the weighted aggregated deviation and the weighted quadratic aggregation.

### RELATED APPLICATION DATA

This application claims priority to India Patent Application No. 4294/CHE/2013, filed Sep. 23, 2013, the disclosure of which is hereby incorporated by reference in its entirety.

### FIELD OF THE INVENTION

The present invention relates generally to bug prediction techniques in a software application. More specifically, the present invention relates to a method and system for quantifying a bug detection efficiency of a bug prediction technique applied on the software application.

### BACKGROUND

A current practice of software maintenance includes taking corrective actions, after bugs are reported by end users in software, post deployment of the software. Such practice, results in degradation of software quality, usability and overall response time for support activities. Thus a better approach lies in preventing bugs prior to the deployment of the software. Such an approach may be referred to as preventive maintenance. Preventive maintenance is a means by which one may anticipate and correct the bugs in the software, before the end users detect the bugs post deployment of the software.

A typical bug prediction technique (BPT) may implement approaches such as heuristic, machine learning, and regression analysis on various software artifacts in order to predict and identify potential bugs in the software. Certain bug prediction frameworks, may analyze a source code and a bug history data of the software. However none of the existing BPT, evaluate the efficiency or quality of the BPT, in unraveling the potential bugs in the software. Thus, there exists a challenge in quantifying a preventability of the BPT, in terms of a capability of the BPT in identifying bugs.

Hence an alternative system and method is required for quantifying the BPT applied on the software. A software quality measure known as a bug preventability measure for quantifying the quality and efficiency of the BPT has been proposed. The alternate system and method must compute the preventability measure of the BPT applied on the software. Thus a system and method for quantifying the bug preventability measure of the bug prediction technique is proposed.

### SUMMARY

The present invention provides a method and system for quantifying a bug preventability measure of a bug prediction technique. In accordance with a disclosed embodiment, the method may include applying a weighted recursive function, on an actual bug count of each version of an application, for computing a golden bug count of the each version. Further, the method shall include deriving a set of source code parameters of the application and applying a linear regression model, on the set of source code parameters of the each version of the application in order to calculate a predicted bug count for the each version. A weighted aggregated deviation between the predicted bug count and the golden bug count of the each version, and a weighted quadratic aggregation of a maximum of the predicted bug count and the golden bug count of the each version may be computed. A bug deviation ratio, which shall be indicative of the bug preventability measure, can be defined as a ratio of the weighted aggregated deviation and the weighted quadratic aggregation.

In an additional embodiment, a system for quantifying a bug preventability measure of a bug prediction technique has been proposed. The system comprises a projection module, configured to compute a golden bug count of each version of an application by applying a weighted recursive function on an actual bug count of the each version. The system further includes a prediction module, configured to compute a predicted bug count of the each version of the application from a set of source code parameters, and a computing module, configured to compute a weighted aggregated deviation between the predicted bug count and the golden bug count of the each version, and a weighted quadratic aggregation of a maximum of the predicted bug count and the golden bug count of the each version. Finally the system shall include a measuring module configured to compute the bug preventability measure as a unitary deviation of a ratio of the weighted aggregated deviation and the weighted quadratic aggregation.

These and other features, aspects, and advantages of the present invention will be better understood with reference to the following description and claims.

### BRIEF DESCRIPTION OF THE DRAWINGS

FIG. 1 is a flowchart illustrating an embodiment of a method for quantifying a bug preventability measure of a bug prediction technique.

FIG. 2 is a flowchart illustrating a preferred embodiment of a method for quantifying a bug detection efficiency of a bug prediction technique

FIG. 3 shows an exemplary system for quantifying a bug detection efficiency of a bug prediction technique.

FIG. 4 illustrates a generalized example of a computing environment 400.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for quantifying a bug detection efficiency in terms of a bug preventability measure of a bug prediction technique. More specifically the methods and systems disclosed shall parse a source code of a software application and analyze a bug history data of the software application for quantifying and calculating the bug preventability measure.

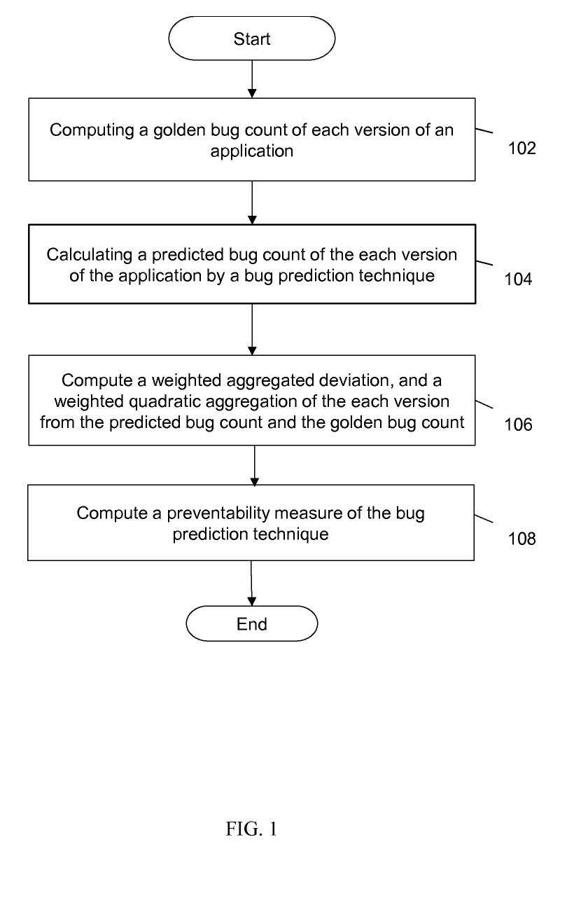

FIG. 1 is a flowchart that illustrates a method performed for quantifying a bug detection efficiency of a bug prediction technique in accordance with an embodiment of the present invention. At step 102, a golden bug count of each version of the application can be calculated. A weighted recursive function can be applied on an actual bug count of each version of an application for calculating the golden bug count of the each version. The actual bug count maybe calculated on parsing a bug history data of the application. Further, at step 104, a predicted bug count of each version of the application can be calculated by a bug prediction technique. A set of source code parameters of the application can be derived by parsing a source code of a latest version of the application. The set of source code parameters may vary with a type of the application and the bug prediction technique used. Further, a linear regression model can be applied on the set of source code parameters for calculating the predicted bug count of the application. At step 106, a weighted aggregated deviation can be calculated between the predicted bug count and the golden bug count of the each version; and a weighted quadratic aggregation of a maximum of the predicted bug count and the golden bug count of the each version can be calculated. Finally at step 110, a preventability measure of the bug prediction technique may be calculated. The bug preventability measure can be computed as a unitary deviation from a bug deviation ratio, where the bug deviation ratio is a ratio of the weighted aggregated deviation and the weighted quadratic aggregation. The bug preventability measure can be an indicator of the bug detection efficiency of the bug prediction technique.

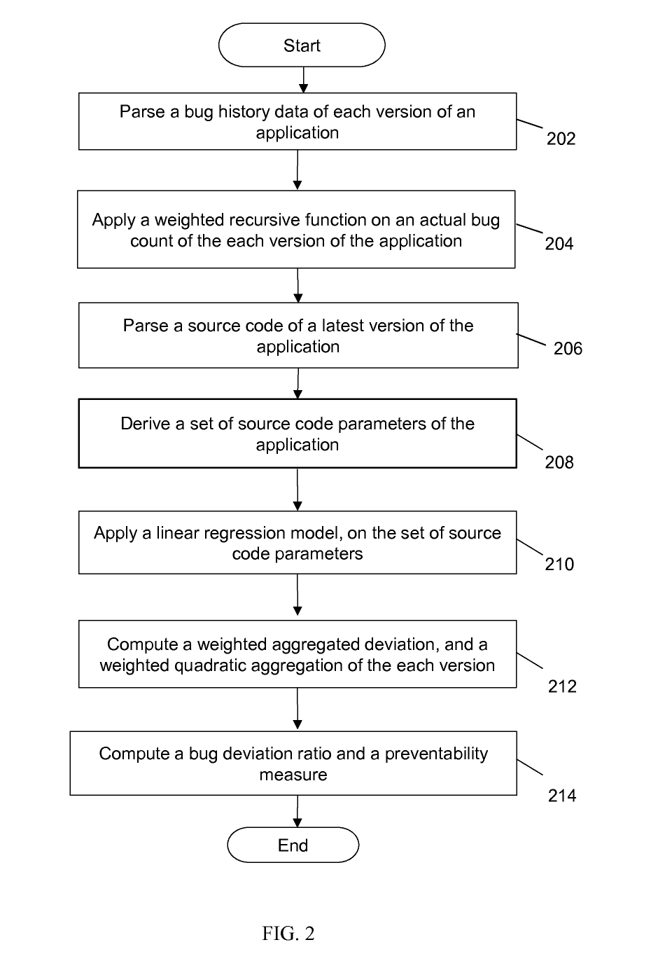

FIG. 2 illustrates an alternate embodiment of practicing the invention. At step 202, a bug history data of each version of a software application can be parsed. At step 204, a weighted recursive function may be applied on an actual bug count of a current version and a golden bug count of a previous version of the software application. The weighted recursive function usually depends on a type of the software application. A weighted aggregation can be applied on the actual bug count of existing versions to calculate the golden bug count for a subsequent version. An importance of a recent history viz. the actual bug count in a set of current versions and a previous history viz. the actual bug count in a set of previous versions, is basically considered in the weighted aggregation of the golden bug count calculation. For instance, say we have ten versions released for a software application; calculation of the golden bug count for a second version may be done by multiplying a weightage parameter (α) by the actual bug count of first version. Similarly for calculation of a golden bug count of a third version, a product of a weightage parameter (α) with the actual bug count of the second version can be added to a product of (1-α) with the golden bug count of a third version of the software application. The golden bug count of the second version essentially provides a previous bug history as it can be calculated from the first version. On the other hand, the bug count of the second version provides the current bug history. Such recursive process can be continued, until we calculate a golden bug count for an eleventh version. A value of the weightage parameter (α) depends on a type of the software application. Ideally, the weightage parameter can be set to 0.5, viz. equal weightage may be given to the recent history and the previous history. However, the weightage parameter can be flexibly set by an application developer based on a software usage context. For instance, for an automotive control software the recent history plays an important role, hence, a can be considered less in such instance. However, for, a web based object oriented software application, the previous history plays an important role. Hence, a can be set higher in such instance. As a result the golden bug count represents an actual projection of bugs in a future release of the software application based on the actual bug data for the existing versions.

At step 206, a source code of a latest version of the application can be parsed for obtaining a set of source code parameters. For instance the set of source code parameters may include an afferent coupling (CA), an efferent coupling (CE), an abstractness (A), an instability (I), a distance (D), and a Cycles (V) of the software application. At step 208, the set of source code parameters are derived by processing the step 206. The set of source code parameters can depend on a type of a bug prediction technique used and the type of the software application. For example, a number of interfaces, a number of complex icons, a set of parameters passed, and a depth of a function call tree are important prediction parameters for a graphic user interface (GUI) software application and for a functional program. On the other hand, the afferent coupling, the efferent coupling, the abstractness and a dependency cycle, are important source code parameters for object oriented programs. The type of a bug prediction technique may determine a set of prediction parameters that may be used for bug prediction. Thus, a seed of a bug prediction technique is the set of prediction parameters and the type of the bug prediction technique, used in the bug prediction technique for predicting a final bug count. An instance of a bug prediction technique can be a linear regression model on the set of prediction parameters. However, it is often found that a set of prediction parameters considered by the bug prediction technique may not be sufficient and properly used under the linear regression model for accumulation and prediction of the bugs. The set of prediction parameters selected maybe correct however, due to unavailability of sufficient versions, the linear regression model may not fit well enough for accumulation of the set of prediction parameters across versions. In order to assess an efficiency of the bug prediction technique, at step 210, the linear regression model shall be applied on the set of source code parameters of the each version of the software application for calculating a predicted bug count of the each version. Firstly, based on the actual bug count, a set of linear regression equations shall be solved to find a set of regression co-efficients for the each versions of the software application. A weighted aggregation on the set of source code parameters, a set of regression co-efficient and a set of regression factors shall be applied across all versions for calculation of the predicted bug count. A regression co-efficient varies with the number of versions available and a regression factor varies with the type of the bug prediction technique. An instance of tool that shall provide the set of regression co-efficients and the set of regression factors as a single multiplicative factor associated with the set of source code parameters can be Weka.

At step 212, a weighted aggregated deviation between the predicted bug count and the golden bug count of the each version, and a weighted quadratic aggregation of a maximum of the predicted bug count and the golden bug count of the each version can be calculated. The weighted aggregated deviation, Eβₖ for a k^{th} version of the software application can be expressed as:

$$E {β}_{k} = {\sum }_{i = 1}^{k - 1} {c}_{i} \cdot {\{ {η}_{i + 1} - {ɛ}_{i , i + 1} \}}^{2}$$

Where

nᵢ₊₁ refers to the predicted bug count of the i+1^{th} version of the application;

βₖ refers to the actual bug count of the k^{th} version of the application;

cᵢ refers to a validity bit of the i^{th} version of the application, where cᵢ=1 when the i^{th} version is validated and cᵢ=0 if the ith version is not validated;

ε_{i,i+1}: refers to the golden bug count of the i^{th} version of the application

Eβₖ : refers to the weighted aggregated deviation of the k^{th} version of the application.

Similarly, weighted quadratic aggregation viz. mβₖ can be expressed as;

$$m {β}_{k} = {\sum }_{i = 1}^{k - 1} {c}_{i} \cdot {( max \{ {η}_{i + 1} - {ɛ}_{i , i + 1} \} )}^{2}$$

Further, at step 214, a bug deviation ratio, shall be computed as a ratio of the weighted aggregated deviation and the weighted quadratic aggregation. The bug deviation ratio may be expressed as:

$$Δ r = \frac{E {β}_{k}}{m {β}_{k}}$$

The bug deviation ratio shall indicate a fraction of the potential bugs deviated in terms of the predicted bug count while applying the bug prediction technique. The bug deviation ratio shall indicate a weakness index of the bug prediction technique. If the bug deviation ratio is less, it shall imply that the bug prediction technique is good in predicting the bugs as there shall be lesser deviations of predicted bug count from the golden bug count viz. an actual projected bug count. Therefore, to represent the efficiency or preventability measure or performance index of the bug prediction technique, the bug deviation ratio could be subtracted from 1 to yield the preventability measure. The preventability measure can be equated as: qm=1−Δr. The bug preventability measure can be an indicator of the bug detection efficiency of the bug prediction technique.

Hence, an event where the bug deviation ratio is less than the preventability measure will be higher. The preventability measure shall lie in a range of [0,1]. A high value of the preventability measure indicates a better efficiency of the bug prediction technique in terms of bug prediction.

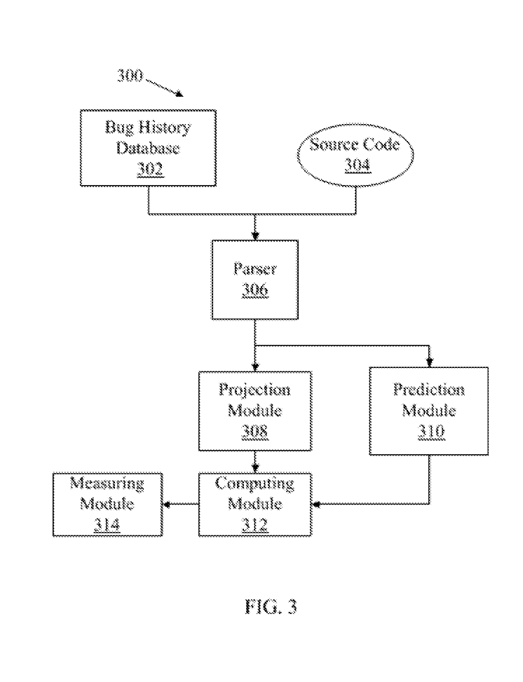

FIG. 3 illustrates an exemplary system 300 in which various embodiments of the invention can be practiced. The system comprises of a bug history database 302, a source code 304 of an application being tested, a parser 306, a projection module 308, a prediction module 310, a computing module 312, and a measuring module 314. The bug history database 302, can be configured to store a bug history data of the application. The source code 304, may include a set of version of the application. The parser 306, can be configured to parse the bug history data of each version of the application, and count an actual bug count in the each version of the application. The parser 306, can be further configured to parse the source code 304, of a latest version of the application, and derive the set of source code parameters of the application. The projection module 308, can be configured to project a golden bug count of the each version of the application by applying a weighted recursive function on the actual bug count of the each version. The prediction module 310, can be configured to compute the predicted bug count of the each version of the application from the set of source code parameters. The computing module 312, can compute a weighted aggregated deviation between the predicted bug count and the golden bug count of the each version, and a weighted quadratic aggregation of a maximum of the predicted bug count and the golden bug count of the each version. The weighted quadratic aggregation and the weighted aggregated deviation can be provided as inputs to the measuring module 314, for computing a bug preventability measure as a unitary deviation of a ratio of the weighted aggregated deviation and the weighted quadratic aggregation.

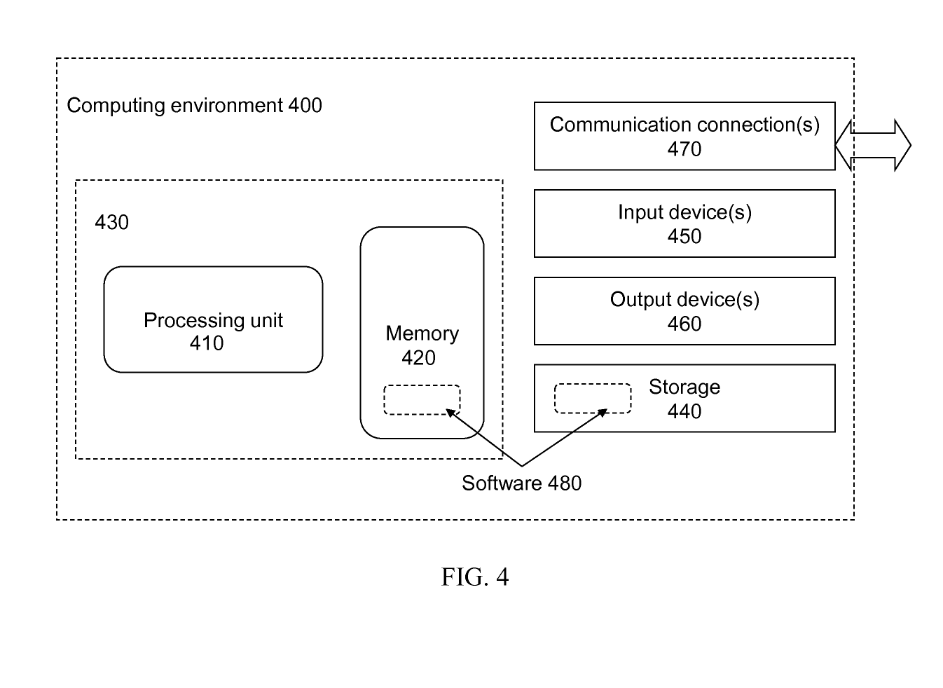

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method for quantifying a bug detection efficiency of a bug prediction technique, the method comprising:
applying a weighted recursive function, on an actual bug count of each version of an application, for computing a golden bug count of an each subsequent version;
applying a linear regression model, on a set of source code parameters of the each version of the application for calculating a predicted bug count for the each version;
computing a weighted aggregated deviation between the predicted bug count and the golden bug count of the each version, and a weighted quadratic aggregation of a maximum of the predicted bug count and the golden bug count of the each version; and
computing a bug deviation ratio as a ratio of the weighted aggregated deviation and the weighted quadratic aggregation.

2. The method of claim 1, further comprising:
parsing a bug history data of the each version of an application;
parsing a source code of a latest version of the application; and
computing a preventability measure as a unitary deviation of the bug deviation ratio.

3. The method of claim 2, wherein:
the actual bug count is obtained by the step of parsing a bug history data of the each version of the application; and
the set of source code parameters is obtained by the step of parsing a source code of a latest version of the application.

4. The method of claim 3, wherein the weighted recursive function includes a weighted aggregate of an actual bug count of a current version and a golden bug count of a previous version, whereby the weighted aggregate is based on a type of the application.

5. The method of claim 4, wherein the set of source code parameters depend on the type of the application and a type of the bug prediction technique.

6. The method of claim 1, wherein the set of source code parameters include, an afferent coupling, a efferent coupling, an abstractness, an instability, a distance, and a cycles.

7. The method of claim 5, wherein the step of applying a linear regression model, includes computing a weighted aggregate of the set of source code parameters with a set of related regression coefficients and a set of regression factors.

8. The method of claim 7, wherein the weighted aggregated deviation and the weighted quadratic aggregation is computed for a set of validated versions of the application.

9. The method of claim 7, wherein the set of regression coefficients depends on a number of available versions of the application, and the set of regression factors depends on the type of the bug prediction technique.

10. The method of claim 1, wherein the bug preventability measure is an indicator of the bug detection efficiency.

11. A system to quantify a bug detection efficiency of a bug prediction technique, the system comprising:
a projection module configured to project a golden bug count of an each subsequent version of an application by applying a weighted recursive function on an actual bug count of the each version;
a prediction module, configured to compute a predicted bug count of the each version of the application from a set of source code parameters;
a computing module, configured to compute a weighted aggregated deviation between the predicted bug count and the golden bug count of the each version, and a weighted quadratic aggregation of a maximum of the predicted bug count and the golden bug count of the each version; and
a measuring module configured to compute the bug preventability measure as a unitary deviation of a ratio of the weighted aggregated deviation and the weighted quadratic aggregation.

12. The system of claim 1, further comprising:
a bug history database configured to store a bug history data of the application;
a parser configured to parse the bug history data of the each version of the application, and count the actual bug count in the each version of the application.

13. The system of claim 12, wherein the parser is further configured to:
parse a source code of a latest version of the application; and
derive the set of source code parameters of the application.

14. The system of claim 11, wherein the prediction module is further configured to apply a linear regression model on the set of source code parameters of the each version of the application for computing the predicted bug count.

15. The system of claim 11, wherein the weighted recursive function includes a weighted aggregate of an actual bug count of a current version and a golden bug count of a previous version, whereby the weighted aggregate is based on a type of the application.

16. The system of claim 15, wherein the set of source code parameters depend on the type of the application and a type of the bug prediction technique.

17. The system of claim 11, wherein the set of source code parameters include, an afferent coupling, a efferent coupling, an abstractness, an instability, a distance, and a cycles.

18. The system of claim 14, wherein the linear regression model, includes computing a weighted aggregate of the set of source code parameters with a set of related regression coefficients and a set of regression factors.

19. The system of claim 11, wherein the weighted aggregated deviation and the weighted quadratic aggregation is computed for a set of validated versions of the application.

20. The system of claim 19, wherein the set of regression coefficients depends on a number of available versions of the application, and the set of regression factors depends on the type of the bug prediction technique.

21. A computer program product consisting of a plurality of program instructions stored on a non-transitory computer-readable medium that, when executed by a computing device, performs a method for quantifying a bug detection efficiency of a bug prediction technique, the method comprising:
applying a weighted recursive function, on an actual bug count of each version of an application, for computing a golden bug count of an each subsequent version;
deriving a set of source code parameters of the application;
applying a linear regression model, on the set of source code parameters of the each version of the application for calculating a predicted bug count for the each version;
computing a weighted aggregated deviation between the predicted bug count and the golden bug count of the each version, and a weighted quadratic aggregation of a maximum of the predicted bug count and the golden bug count of the each version; and
computing a bug deviation ratio as a ratio of the weighted aggregated deviation and the weighted quadratic aggregation.
